(19) United States
(12) Patent Application Publication
(10) Pub. No.: US 2012/0179778 A1
(43) Pub. Date: Jul. 12, 2012

(54) APPLYING NETWORKING PROTOCOLS TO IMAGE FILE MANAGEMENT

(75) Inventors: Stephanus Jansen DeSwardt, Los Altos, CA (US); Niels Joubert, Los Altos, CA (US); Abraham Benjamin de Waal, San Jose, CA (US); Pieter Hendrik Joubert, Los Altos, CA (US)

(73) Assignee: BruteSoft, Inc., Los Altos, CA (US)

(21) Appl. No.: 13/345,946

(22) Filed: Jan. 9, 2012

Related U.S. Application Data
(63) Continuation-in-part of application No. 13/012,785, filed on Jan. 24, 2011.
(60) Provisional application No. 61/297,520, filed on Jan. 22, 2010.

(51) Int. Cl. G06F 15/16

(52) U.S. Cl. 709/217

(57) ABSTRACT

A method and system provides for the migration of a modified virtual machine from a first network environment to a second by transmitting only a new value-block pair and a new set of key-value pairs to a client in the second network environment. Changes to the virtual machine, which is composed of component blocks, may be captured in a new component block. A corresponding new key and new hash value maybe generated to produce the new value-block pair and a corresponding new key-value pair. In this way, a user may make changes to a virtual machine in the first network environment and have those changes distributed and made available in the second network environment; not by transferring the entire image file, but rather by transferring a minimal amount of data between the two environments.

### CROSS-REFERENCE TO RELATED PATENT DOCUMENTS

This patent application claims a priority benefit and is a continuation-in-part application of U.S. patent application Ser. No. 13/012,785, filed Jan. 24, 2011, and entitled “APPLYING PEER-TO-PEER NETWORKING PROTOCOLS TO VIRTUAL MACHINE (VM) IMAGE MANAGEMENT”; which claims the priority benefit of U.S. Provisional Application No. 61/297,520, filed Jan. 22, 2010, and entitled “APPLYING PEER-TO-PEER NETWORKING PROTOCOLS TO VIRTUAL MACHINE (VM) IMAGE MANAGEMENT”; and all of which are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011, BRUTESOFT, INC. All Rights Reserved.

### TECHNICAL FIELD

The present application relates generally to the technical field of data processing and more particularly to applying networking protocols to image file management.

### BRIEF DESCRIPTION OF TEE DRAWINGS

Some embodiments are illustrated by way of example and not limitation in the figures of the accompanying drawings in which:

FIG. 1 is a block diagram illustrating a network environment in which network protocols may be applied to virtual machine image file management;

FIG. 2 is a diagrammatic representation of a data structure associating hash values to component blocks and corresponding keys, according to some example embodiments;

FIG. 3 is a diagrammatic representation of a data structure relating to an image file update, according to some embodiments;

FIG. 4 is a flow chart illustrating a method to implement, from a server, an updated virtual machine file in a second network environment, as may be used in some embodiments;

FIG. 5 is a flow chart illustrating a method to implement, from a client, an updated virtual machine file in a second network environment, according to some embodiments; and

FIG. 6 is a block diagram of machine in the example form of a computer system within which is a set of instructions, for causing the machine to perform any one or more of the methodologies discussed herein, that may be executed.

### DETAILED DESCRIPTION

In the following description, for purposes of explanation, numerous specific details may be set forth in order to provide a thorough understanding of some example embodiments. It will be evident, however, to one skilled in the art that the present invention may be practiced without these specific details.

### Environment

A virtual machine (VM) is a software implementation of a complete machine or complete system platform, which is entirety supported by a native operating system of an underlying physical machine. VM image files are the software that implements a VM and are the means by which VMs may be transported across a network to various physical machines, Central servers may contain several VM image files for distribution to any of a number of client machines across a network, such as the Internet. A VM image file may be very large and loaded at any time to any one of several client machines to provide a complete VM implementation for a user.

When a VM is requested by a user on a client machine, the large size of the corresponding VM image file requires a substantial amount of network bandwidth in order to load in a reasonable period of time from a user's perspective. In managing VMs the central server may be required to supply multiple installations of VMs to client machines, migrate VMs from one host platform to another, and provide revision and versioning control to a range of VMs. With a large number of users on remote clusters of client machines, the amount of bandwidth required from the central server to the various client machines may be substantial and over task the network.

Certain implementations of central servers may route image files as a sequence of block transfers from node to node of a network without assessing any cost or penalty for the distance that a block of the image file may have to travel in being transferred from the central server to a target client machine. As a result, the image file transfer conducted by the central server without assessing transfer distances ultimately incurs a delay penalty which may in some cases be a substantial amount of time. This lack of consideration of distance cost may mean that a considerable amount of time is required for any respective block of the VM image file to be propagated to the target client machines and also may mean that a significant cost to resources is incurred during the transfer over long network distances.

### System

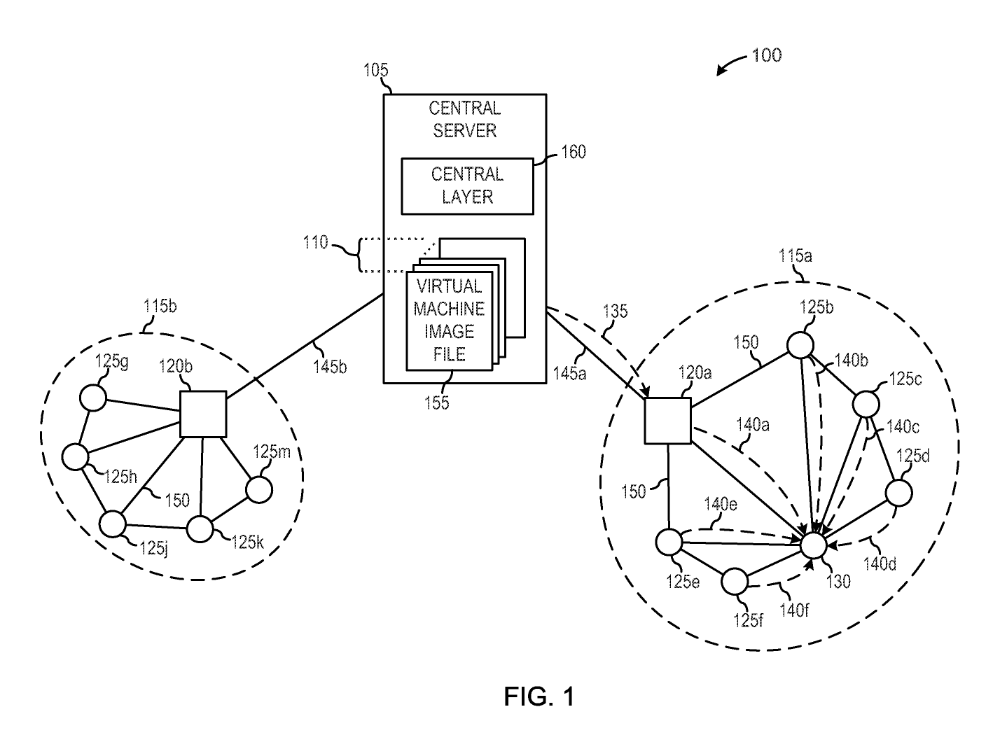

FIG. 1 is an example network environment in which network protocols may be applied to a VM image file management system 100, as may be used in some embodiments. A central server 105 may be communicatively coupled by network connections 145a,b to a set of external client machine clusters 115a,b each including a local host 120a,b and a collection of external client machines 125b-f, 125g-m and a target client machine 130. In some embodiments, an external client machine cluster may include only external client machines and no local host (not shown). Each of the external client machines 125b-f, 125g-m and the target client machine 130 may be communicatively coupled to one another through various combinations of further network connections 150 (of which only a few are labeled in FIG. 1 for brevity and clarity) within the respective external client machine clusters 115a,b. The central server 105 may contain VM image files 110 including a first VM image file 155. Any one of the VM image files 110 may be intended for copying to the target client machine 130 within a first cluster of machines 115a. Any of the external client machines 125b-f, 125g-m in further embodiments may operate as a target client machine and may receive any one of the VM image files 110.

The central server 105 may also include a central layer 160, which deals with the metadata relating to the VMs. The central layer 160 may receive requests for certain of the VM image files 110 to be implemented as a corresponding VM on a particular one of the external client machines 125b-f, 125g-m. The central layer 160 may also receive requests to migrate a VM, update an existing VM, as well as build a particular VM at a user's login to a particular physical machine. Each of the requests to process or transform a VM may be handled by the central layer 160 as a process or transformation on one or more of the VM image files 110. In this way, the central layer 160 provides centralized control of VM management and takes advantage of a hierarchical nature inherent in the network connectivity of client machines. The central layer 160 may incorporate peer-to-peer network protocols to implement the processes for migrating and updating the VM image files 110.

An initial transmission 135 of the first VM image file 155 may be conducted by the central server 105 to variously distribute a set of component blocks (not shown) that constitute the first VM image file 155 to certain of the external client machines 125b-f and local host 120a of the first cluster of machines 115a. The initial transmission 135 may be accomplished using peer-to-peer protocols. Each of the component blocks (described below) may be a portion of the first VM image file 155 and may have an associated key used to identify the respective portion of the first VM image file 155. By being variously distributed through the peer-to-peer protocols, the component blocks may be distributed such that certain of the external client machines 125b-f may receive more than one component block while others may not receive any component blocks at all. In their totality, the set of component blocks constitutes the first VM image file 155.

To receive the first VM image file 155, the target client machine 130 may inquire of the local host 120a and the external client machines 125b-f using a peer-to-peer protocol to identify which of the machines may have which of the component blocks of the first VM image file 155. Through nearby copying operations 140a-f occurring between the local host 120a, the external client machines 125b-f, and the target client machine 130, the fun set of component blocks may be transmitted to the target client machine 130 and assembled as the first VM image file 155.

By inquiring of nearby client machines in the first cluster of machines 115a, the target client machine 130 may assure selection of each respective component block from a nearby client machine in the form of the external client machines 125b-f. This ability to select component blocks from nearby client machines through peer-to-peer protocols ensures that minimal network resources are involved in transmitting the component blocks to the target client machine 130. Not only does this minimize the impact on resources of the network, it also assures a minimal amount of time is used in transferring the respective component blocks.

Additionally, the target client machine 130 may effectively throttle the amount of bandwidth required to assemble the set of component blocks by moderating the requests to nearby client machines. This practice also inherently assures a significant degree of load-balancing since the external client machines 125b-f supplying the component blocks may do so in parallel and with a continuous stream of supplied data. This continuous stream of supplied data is possible since a significant use of receive/acknowledge hand shaking is not required as is the case in classical protocols involving a single data source. The target client machine 130 may also distinguish nearby client machines providing the best service and preferentially request component blocks from the external client machines 125b-f with the best service record. Distinctions in service capabilities along with the relatively small file sizes involved in providing the component blocks means that the target client machine 130 may have an additional way to inherently load balance network resources while managing VM image files 110.

Using the peer-to-peer protocols between the local host 120a and the external client machines 125b-f, requests may be placed at a rate appropriate to the bandwidth that the target client machine 130 may have available and that can be sustained by the further network connections 150 between nearby client machines. In certain embodiments, although the bandwidth of the target client machine 130 and the further network connections 150 may be able to sustain a substantially high bandwidth, it may be in the interest of power conservation to use a throttling capabilities available to the target client machine 130 to maintain a rate of requests to nearby client machines that ensures the amount of power consumed in transferring an image file from nearby client machines is kept at or below a certain threshold targeted for power conservation and encompassing enterprise.

Generally, when component blocks may be acquired locally in the peer-to-peer network fewer resources are required and less power is consumed and thus less cost is incurred. In some embodiments it may also be possible to use fewer physical machines when VM image files 110 are readily available as may be possible according to the processes described here. Additionally, each physical machine provided to users may not have to be as heavily provisioned with various VM image files when those files may otherwise be as readily available as described here. This feature may be made possible by the rapid ability to reconfigure VM machines on physical machines according to the processes described herein.

Cumulatively, the nearby copying operations 140a-f may provide a significantly higher total bandwidth for copying the first VM image file 155 to the target client machine 130 than would be available in a straight through transmission of the first VM image file 155 from the central server 105 directly to the target client machine 130. The bandwidth of the connections from the central server 105, through the first network connection 145a, and directly to the target client machine 130 are typically, and often necessarily, less than the cumulative bandwidth of the nearby copying operations 140a-f. In this way, the local host 120a and the external client machines 125b-f may provide the first VM image file 155 to the target client machine 130 and do so more quickly than would a single inline transmission from the central server 105. In this way, copying the first VM image file 155 to the target client machine 130 may be accomplished at the user's initial log in to a physical machine significantly faster than a straight through transmission from the central server 105. If there are unique files necessary to make up the first VM image file 155 they may still be pulled from the central server 105. Generally, the volume of unique files is very small compared to the entire first VM image file 155 and rapid configuration of the VM is still possible in the case of these unique files being required for the first VM image file 155 to be complete.

This peer-to-peer copying process is likewise available, for example, between any of the local hosts 120a,b and external client machines 125b-f, 125g-m. In some embodiments, nearby client copying may be facilitated by having an agent (not shown) installed on any or each of the local hosts 120a,b and external client machines 125b-f, 125g-m. The localized copying process additionally avoids the possibility of saturating the single in-line transmission bandwidth from the central server 105 to the several target machines within the external client machine clusters 115a,b. The peer-to-peer copying process produced as described above may be exercised at any time, including common workplace hours, without disruption of network traffic due to typical workplace activities. Additionally, the problem of a multicast distribution of files and the requirement of perfect coordination of the receipt of each packet with no interruptions or failures on the part of each receiving machine in that type of transmission is avoided by having each installed agent able to manage the sharing of installation information and appropriate portions of the target files with other agents.

### Data Structures

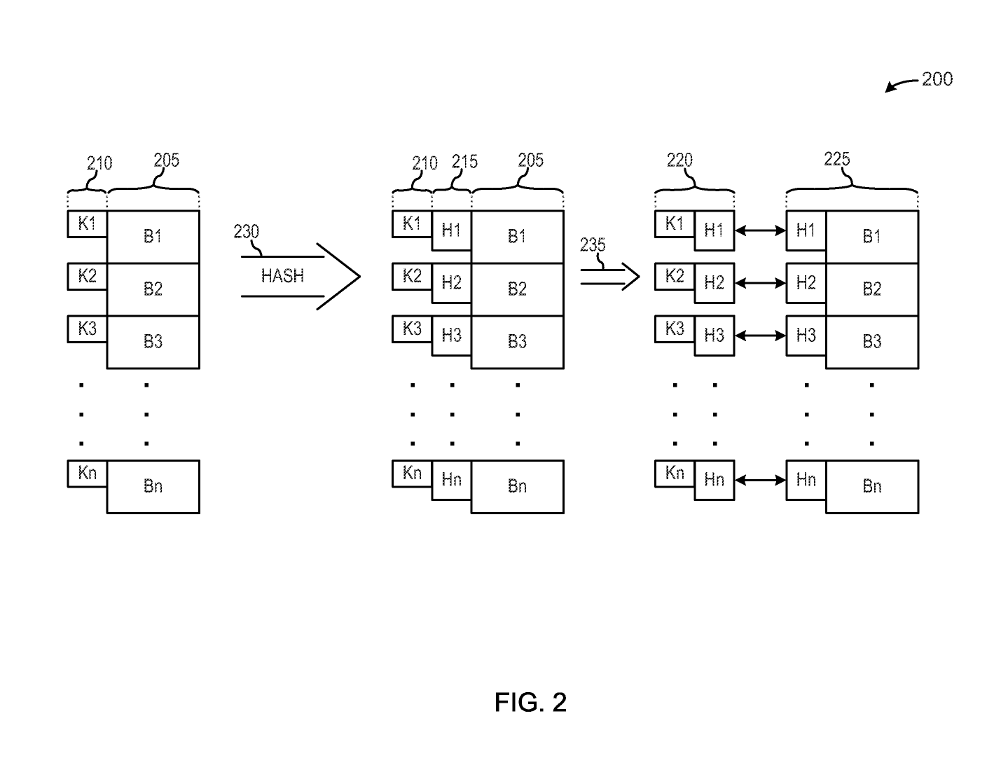

FIG. 2 is a diagrammatic representation of a data structure associating hash values to component blocks and corresponding keys 200 according to some example embodiments. Any of the VM image files 110 may be fractured into a set of component blocks B1-Bn 205 with associated keys K1-Kn 210 being generated that identify each respective block. The keys K1-Kn 210 are submitted to and used in a hash function 230 to produce a set of hash values 215 corresponding to each respective combination of key and component block K1B1-KnBn. Each key K1-Kn 210 is combined with a corresponding hash value H1-Hn 215 in a transposing process 235 to form a set of key-value pairs K1H1-KnHn 220. The set of key-value pairs K1H1-KnHn 220 is sufficient to delineate a complete configuration of the corresponding VM image file 110. The transposing process 235 also combines a respective one of the hash values H1-Hn 215 with a corresponding one of the component blocks B1-Bn 205 to form a set of value-block pairs H1B1-HnBn 225.

The set of value-block pairs H1B1-HnBn 225 is kept in distributed hash tables (DHTs) which are retained in various ones of the local hosts 120a,b and external client machines 125b-f, 125g-m. An agent may be installed on any of the local hosts 120a,b and external client machines 125b-f, 125g-m to assist in managing the DHTs (not shown) and the set of value-block pairs H1B1-HnBn 225. The agent may manage DHTs on the same client machine that the agent is installed on or on nearby client machines through use of peer-to-peer protocols.

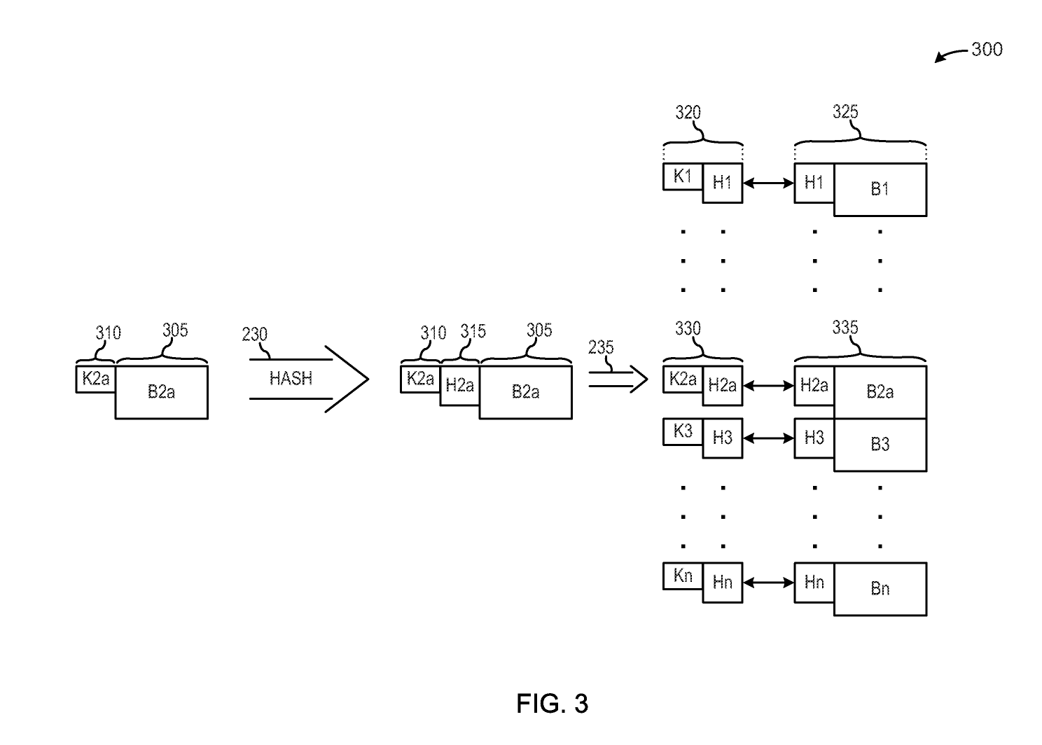

FIG. 3 is a diagrammatic representation of an image file update 300, according to some embodiments. A user may produce an update to one of the VM image files 110 at any time during a terminal session with a client device in a network environment. At a later time, the user may login to a further client device in a further network environment and may be able to retrieve the updated VM image file 110 and proceed with a further terminal session, picking up where the first terminal session may have left off. An update to one of the VM image files 110 may be implemented with one or more new component blocks, modified component blocks, or removed component blocks, or any combination of newly added, modified, or removed component blocks. Anyone of the new or modified component blocks may replace one or more existing component blocks or be positioned appropriately in the file as an additional component block.

A new or modified component block B2a 305 may be assigned anew key K2a 310 that is generated when the update to the VM image file 110 is complete. The new key K2a 310 is used in the hash function 230 to produce a new hash value H2a 315 corresponding to the combination of the new key K2a 310 and the new component block B2a 305. The new key K2a 310 may be combined with the new hash value H2a 315 in the transposing process 235 to form a new key-value pair K2aH2a 330. The transposing process 235 also combines the new hash value 142a 315 with the new component block B2a 305 to form a new value-block pair H2aB2a 335.

As a result of the generation of new key-value pair K2aH2a 330 and the new value-block pair H2aB2a 335, a new set of key-value pairs K1H1-KnHn 320 and a new set of value-block pairs H1B1-HnBn 325 may be produced. According to some exemplary embodiments, the new key-value pair K2aH2a 330 and the new value-block pair H2aB2a 335 may replace the key-value pair K2H2 and the value-block pair K2H2 (FIG. 2) respectively in the new set of key-value pairs K1H1-KnHn 320 and the new set of value-block pairs H1B1-HnBn 325. The new set of key-value pairs K1H1-KnHn 320 may form a new configuration of a corresponding one of the initial VM image files 110 and the new set of value-block pairs H1B1-HnBn 325 may in turn form a new VM image file (not shown) when the corresponding component blocks are assembled according to the configuration inherent in the new set of key-value pairs K1H1-KnHn 320. According to some example embodiments the new value-block pair H2aB2a 335 may be sent along with replacement/insertion instructions (not shown) to a client device for constructing the new VM image file from the corresponding one of the initial VM image files 110 without having to send the entire remaining set of key value pairs from the original set of key value pairs K1H1-KnHn 220. An agent, resident on a target client device, may be able to drive the new set of key-value pairs K1H1-KnHn 320 from just the new value-block pair H2aB2a 335 and the replacement/insertion instructions.

According to some example embodiments, the hash function 230 and the transposing process 235 may be carried out by the central layer 160. The keys K1-Kn 210 may be generated by the central layer 160 according to generation or receipt of component blocks B1-Bn 205 by the central server 105. Subsequent to generation, the keys K1-Kn 210 may be applied by the central layer 160 to the hash function 230 to produce the set of hash values H1-Hn 215 corresponding to each respective combination of key and component block K1B1-KnBn 210,205. Each key K1-Kn 210 may be combined by the central layer 160 with a corresponding hash value H1-Hn 215 in the transposing process 235 to form the set of key-value pairs K1H1-KnHn 220. In a further step, the central layer 160 may perform the transposing process 235 to produce the set of value-block pairs H1B1-HnBn 225 according to the respective hash values H1-Hn 215.

According to some further example embodiments, the central server 105 may receive keys K1-Kn 210 which may have been generated by the agent (discussed below) and proceed with applying the hash function 230 and the transposing process 235 to the received keys K1-Kn 210. The central server 105 may invoke the central layer 160 to implement the hash function 230 and the transposing process 235. In this way the central server 105 may produce the set of key-value pairs K1H1-KnHn 220 after having received the keys K1-Kn 210 from the agent.

In yet further example embodiments, the central server 105 may receive both the new key K2a 310 and the corresponding new hash value H2a 315 from the agent for the new or modified component block B2a 305. The new key K2a 310 and the corresponding new hash value H2a 315 may have been generated by the agent on the client device. After having received the new key K2a 310 and the corresponding new hash value H2a 315 from the agent, the central server 105 may produce the new key-value pair K2aH2a 330 by applying the transposing process 235. If the central server 105 also receives the new or modified component block B2a 305 from the agent, the corresponding new value-block pair H2aB2a 335 may be produced by the central server 105 with the transposing process 235.

According to some example embodiments, the agent may perform either one or both of the hash function 230 and the transposing process 235. While being installed on the local hosts 120a,b or anyone of the external client machines 125b-f, 125g-m, the agent may generate the keys K1-Kn 210 for any component blocks B1-Bn 205 generated or received by the agent. Correspondingly, the agent may also generate the set of hash values H1-Hn 215 using the hash function 230. In yet a further example embodiment, the agent may also generate the set of key-value pairs K1H1-KnHn 220 and the set of value-block pairs H1B1-HnBn 225 by applying the transposing process 235. After their generation, the set of key-value pairs K1H1-KnHn 220 may be transmitted to the central server 105 for inclusion as a configuration of the corresponding VM image file 110.

Alternately, the agent may transmit the generated keys K1-Kn 210 to the central server 105 for further processing by the central layer 160, such as for generation of hash values and further processing with the transposing process 235 (discussed above). In yet a further example embodiment, the agent may transmit newly generated or received component blocks B1-Bn 205 directly to the central server 105 for application of key generation, the hash function 230, and the transposing process 235; to be performed by the central layer 160 (discussed above).

In some example embodiments, the central layer 160 may be configured as a general-purpose processing device and implemented with a single processor or multiple processors, to implement any of the capabilities and methods described herein. In yet some further example embodiments, the central layer 160 may be implemented with a special-purpose processing device configured to implement the methods and have the capabilities described herein. Configuration of the central layer 160 may be accomplished by a set of instructions embodied on a computer-readable storage medium that when executed by the general-purpose or special-purpose processing device implementing the central layer 160, causes the processing device to perform the operations, capabilities, and methods described herein. For instance, the central layer 160 implemented as a processing device such as the single processor, multiple processors, or the special-purpose device, may be configured to execute the hash function 230 and the transposing process 235.

Implemented as a processing device in some example embodiments, the central layer 160 may be configured to provide for generation of the keys K1-Kn 210 and the new key K2a 310. For example, in some further example embodiments the central layer 160 may also be configured to perform the hash function 230 and generate the set of hash values H1-Hn 215 and the new hash value H2a 315. In yet some further example embodiments, the central layer 160 may be implemented as a processing device and configured to implement the transposing process 235 and may thereby generate the set of key-value pairs K1H1-KnHn 220, set of value-block pairs H1B1-HnBn 225, the new key-value pair K2aH2a 330, and, and the new value-block pair H2aB2a 335. According to some example embodiments, the central layer 160 may be implemented as a processing device, and may provide for transmission and receipt between the central server 105 and client devices in the set of external client machine clusters 115a,b, of any of the component block related quantities mentioned above.

The new set of key-value pairs K1H1-KnHn 320 and the set of key-value pairs K1H1-KnHn 220 may be retained in DHTs. The DHTs may be used to manage the migration of the VM image files 110. Each DHT may contain multiple sets of key-value pairs K1H1-KnHn 220 where each set provides a description of a VM configuration. The DHT in combination with the central layer 160 may manage requests to various pieces of the VM image file 110 by the target client machine 130. By channelling requests for the VM image files 110 through the DHT, a key piece of bandwidth throttling capability is provided. By retaining the new set of key-value pairs K1H1-KnHn 320, the DHT plays an important part in managing the dynamics of changes to the VM image files 110. By having DHTs mounted on or close to local hosts 120a,b and external client machines 125b-f, 125g-m, network distances involved in copying and migrating VM image files 110 may be kept to a minimum. Additionally, efficiency is gained by having one location provided to the local hosts 120a,b and external client machines 125b-f, 125g-m by the DHT for acquiring links to all locations of the component blocks B1-Bn 205.

Additionally, as a network scales and expands, a new machine can check in with a nearby DHT to acquire standard VM image files 110 that may pertain to an organization or enterprise supported by the network. Similarly, new as well as existing client machines may check in with the DHT to determine the availability of an acquire updates and changes to the VM image files 110. An appropriate identifier may be broadcast over the network by the central layer 160 which may trigger appropriate client machines to seek out appropriate updates from the DHT. Through mechanisms such as these, the DHT can operate as an interface to programmer-level developments that may be necessary to maintain a complete and up-to-date set of the VM image files 110 in support of the enterprise. These same mechanisms for updates and migration of the VM image file 110 are able to change the content of the fabric of the peer-to-peer network on the fly.

VM management may be enhanced by using DHTs in combination with the central layer 160. By incorporating the central layer 160 a VM management system may make possible remote control of peer nodes in a peer-to-peer network. No personnel may be required to login to one of the local hosts 120a,b or external client machines 125b-f, 125g-m to attend to the copying or migration of a VM image file 110. The central layer 160 in conjunction with DHTs may provide for the automation of the VM image file management system 100. By use of the central layer 160 has the centralized control over the peer-to-peer network hierarchy, component blocks B1-Bn 205 of the VM image file 110 may be able to reside across multiple client machines instead of having to reside on the central server 105. With the centralized control provided by the central layer 160, the VM image file 110 may exist as the set of component blocks B1-Bn 205 and still be configured and delivered quickly to the target client machines 130.

With distribution of the set of component blocks B1-Bn 205 across the local hosts 120a,b or external client machines 125b-f, 125g-m and managed by the central layer 160 the automatic distribution of the VM image file 110 may be done by polling and acquiring all necessary component blocks B1-Bn 205 from a set of nearby clients in the peer-to-peer network. By so doing, the central layer 160 may assemble the VM image file 110 on any client machine. When one of the VM image files 110 changes, the central layer 160 need only determine which ones of the set of component blocks B1-Bn 205 and the new component blocks B2a 305 needs to be migrated to the (new) recipient client machine.

To copy, migrate, or reconfigure an existing VM image file 110, the central layer 160 need only distribute the appropriate set of key-value pairs K1H1-KnHn 220 and make sure the corresponding set of value-block pairs H1B1-HnBn 225 is available on nearby client machines in order for the target client machine 130 to be able to assemble the appropriate VM image file 110. In the case of reconfiguring an existing VM image file 110 for example, the central layer 160 may variously distribute a copy or copies of the changes to the VM image file 110 in the form of one or more new component blocks B2a 305 along with the associated new hash values H2a 315 (in the form of the new value-block pair H2aB2a 335) on to certain of the client machines in the peer-to-peer network. The central layer 160 may then only need to distribute the corresponding new key-value pair K2a-H2a 330 along with directives for appropriately positioning the new key-value pair K2a-H2a 330 within the new set of key-value pairs K1H1-KnHn 320 to the client machines and DHTs to bring about distribution of the reconfigured VM image file 110. In this way, only the changes in the updated image file need be distributed by the central layer 160 to effect distribution of the update to the complete reconfigured VM image file 110.

By searching and inquiring of nearby clients or by use of the DHT, the target client machine 130 may locate all of the various component blocks B1-Bn 205 in the list of hashes contained in the set of key-value pairs K1H1-KnHn 220 (and new set of key-value pairs K1H1-KnHn 320 when appropriate). The target client machine 130 may then assemble the component blocks B1-Bn 205 corresponding by hash values in the set of key-value pairs K1H1-KnHn 220 and assemble the blocks in the order listed in the set of key-value pairs K1H1-KnHn 220 to assemble a requested VM image file 110. In cases such as these, local knowledge incorporated in the installed agent may produce an optimal context and use of the local copies of the component blocks B1-Bn 205. In this way, the hierarchical nature of the peer-to-peer network may be leveraged for the efficient distribution of VM image files 110.

### Methods

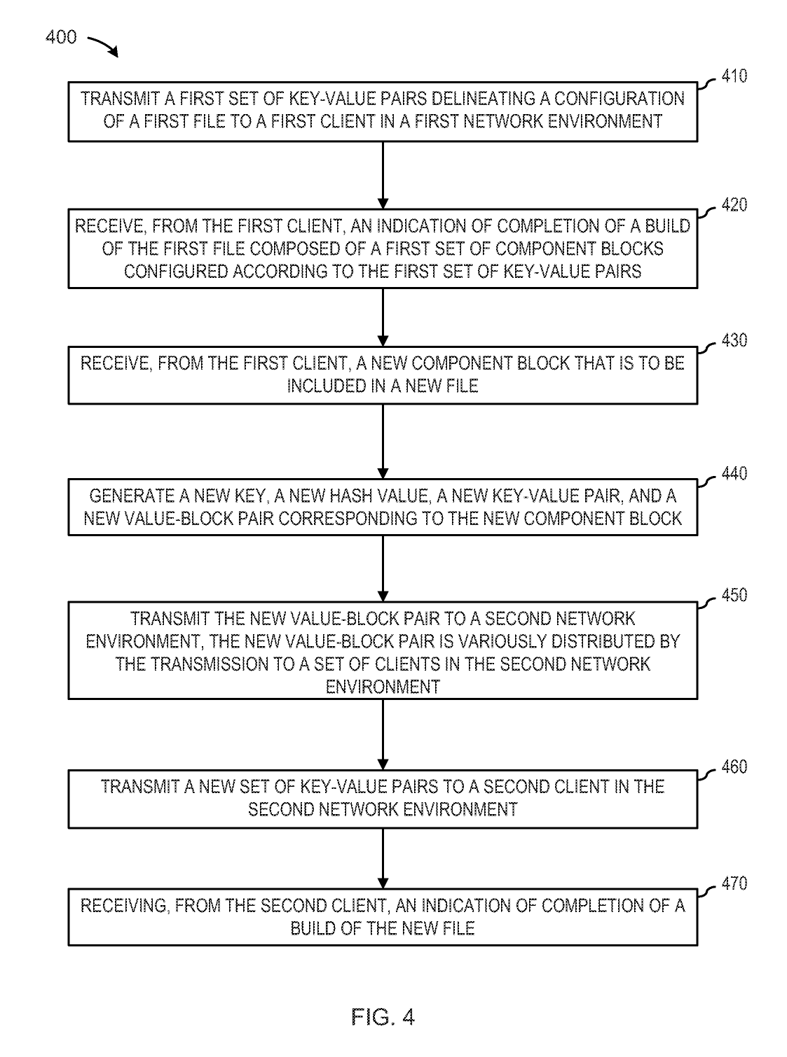

FIG. 4 is a flow chart illustrating a method to implement, according to a server, an updated virtual machine file in a second network environment 400. The method commences with transmitting 410 a first set of key-value pairs delineating a configuration of a first file to a first client in a first network environment. The transmission may be, for example a transmission from a server such as the central server 105 discussed above.

The method continues with receiving 420, from the first client, an indication of completion of a build of the first file composed of a first set of component blocks configured according to the first set of key-value pairs. The first client may, for example, produce the build of the first by gathering the first set of component blocks from adjacent clients by matching hash values from the first set of keypad value pairs. The order of the listing of the keys in the first set of the key-value pairs indicates the sequence that the corresponding component blocks should be built in order to compose the first file.

The method goes on with receiving 430, from the first client, a new component block that is to be included in a new file. The new file may be composed by inserting the new component block is a portion of the first file. The new component block maybe a newly constructed component block or a modified version of a component block from the first set of component blocks composing the first file. In response to receiving the new component block the method continues with, generating 440 a new key, a new hash value, a new key-value pair, and a new value-block pair corresponding to the new component block. These new values may be generated by the central server 105 (discussed above).

The method includes transmitting 450 the new value-block pair to a second network environment, the new value-block pair being variously distributed by the transmission to a set of clients in the second network environment. The central server 105 may transmit the new value-block pair to the set of clients in the second network environment in quantities and with a distribution configured to optimize the gathering of the associated component blocks with the greatest facility by a typical client. The method continues with transmitting 460 a new set of key-value pairs to a second client in the second network environment. The same user that produced the new component block and the new file at the first client in the first network environment may utilize the second client to conduct a build of the new file. The method concludes with receiving 470, from the second client, an indication of completion of a build of the new file. The indication of build completion may be received at the central server 105.

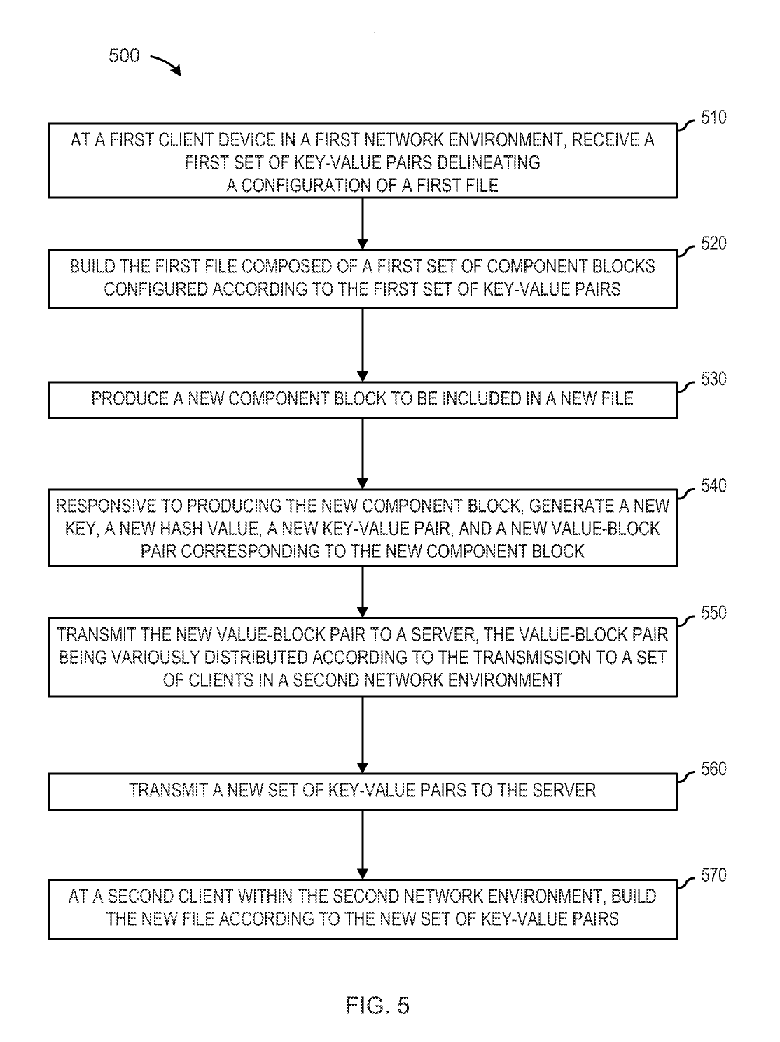

FIG. 5 is a flow chart illustrating a method to implement, according to an agent, an updated virtual machine file in a second network environment 500. The method commences at a first client device in a first network environment, by receiving 510 a first set of key-value pairs delineating a configuration of a first file. The first file may have been fractured into the first set of component blocks with corresponding keys from the first set of key-value pairs. The first set of keys may have been assigned respectively and in sequence to the fractured component blocks. The respective values are hash values correspond to each key and component block. The method continues with building 520 the first file composed of a first set of component blocks configured according to the first set of key-value pairs. The sequence of keys delineates the sequence, and therefore configuration, that the set of component blocks is built in order to compose the first file. The component blocks may be gathered from adjacent clients in the first network environment by using the hash values as an index and locator for the respective component blocks.

The method goes on by producing 530 a new component block to be included in a new file. As with the preceding method (FIG. 4), the new file may be composed by inserting the new component block as a portion of the first file. The new component block maybe a newly constructed component block or a modified version of a component block from the first set of component blocks composing the first file. Responsive to producing the new component block, the method advances by generating 540 a new key, a new hash value, a new key-value pair, and a new value-block pair corresponding to the new component block. By use of an agent implemented at the client device, a key generation function, a hashing function, and a transposing function may be facilitated at a client device in order to generate these new component block-related quantities.

The method progresses by transmitting 550 the new value-block pair to a server, the value-block pair maybe variously distributed according to the transmission to a set of clients in a second network environment. The server may be the central server 105, which may transmit the new value-block pair to the set of clients in the second network environment in quantities and with a distribution configured to optimize the gathering of the associated component blocks with the greatest facility by a typical client. The configuration of the distribution may be determined by an algorithm specifically developed for a uniform utilization of component blocks in a peer-to-peer network environment. The method carries forward with transmitting 560 a new set of key-value pairs to the central server 105.

At a second client within the second network environment, the method concludes with producing 570 a build of the new file according to the new set of key-value pairs. With the first set of component blocks resident in the second network environment, the central server 105 may need only perform two tasks to allow the second client to build the new file in the second network environment. A first task is to transmit the new component block (in the new value-block pair) for distribution in the second network environment and the second task is to transmit, to the second client, the new set of key-value pairs.

### Modules, Components and Logic

Certain embodiments are described herein as including logic or a number of components, modules, or mechanisms. Modules may constitute either software modules (e.g., code embodied on a machine-readable medium) or hardware modules. A hardware module is tangible unit capable of performing certain operations and may be configured or arranged in a certain manner. In example embodiments, one or more computer systems a standalone, client or server computer system) or one or more hardware modules of a computer system (e.g., a processor or a group of processors may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments,

### Machine Architecture

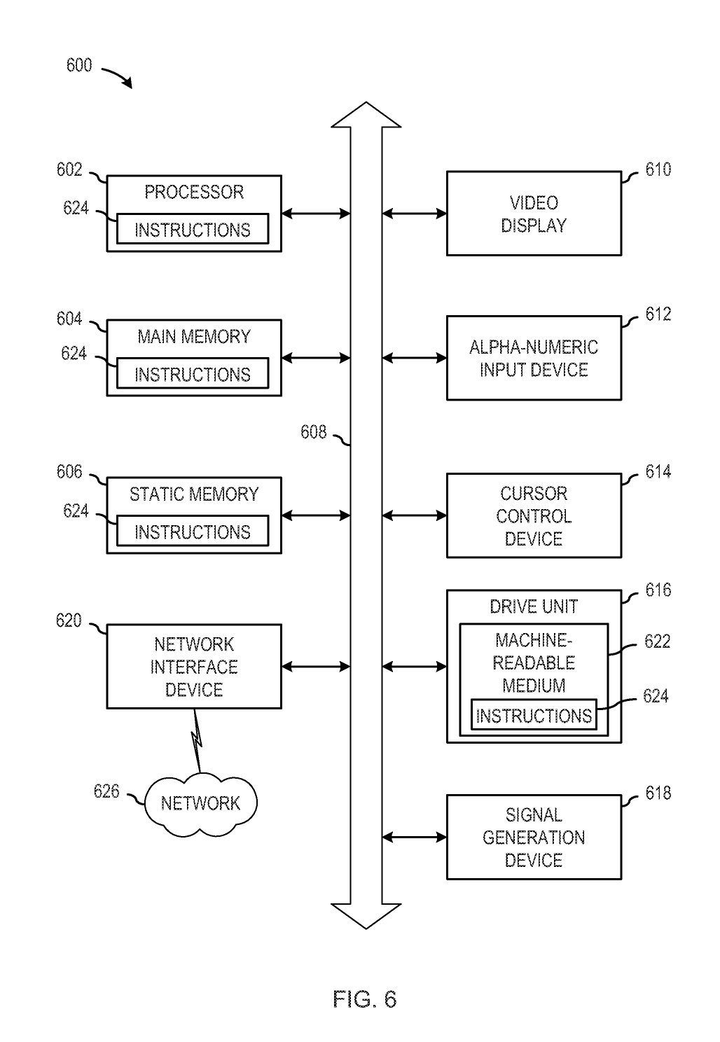

FIG. 6 is a block diagram of a machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse or cursor control device for), a disk drive unit 616, a signal generation device 618 (e.g., a speaker) and a network interface device 620.

### Machine-Readable Medium

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include nonvolatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks).

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the hill range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Thus, a method and system to applying cloud computing as a service for enterprise software and data provisioning have been described. Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense.

Plural instances may be provided for components, operations, or structures described herein as a single instance. Finally, boundaries between various components, operations, and data stores may be somewhat arbitrary, and particular operations may be illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving; from a first client in a first network environment, a new component block being included in a new file;
responsive to receiving the new component block, generating a new key, a new hash value, a new key-value pair, and a new value-block pair corresponding to the new component block;
transmitting the new value-block pair to a second network environment, the new value-block pair being variously distributed by the transmission to a set of clients in the second network environment;
transmitting a new set of key-value pairs to a second client in the second network environment; and
receiving, from the second client, an indication of completion of a build of the new file.

2. The method of claim 1, wherein the new set of key-value pairs includes the new key-value pair and one of a portion of a first set of key-value pairs and a directive introducing the new key-value pair into a first set of key-value pairs.

3. The method of claim 2, wherein introducing the new key-value pair being one of replacement of an existing key-value pair and insertion of the new key-value pair in an existing set of key-value pairs in the second network environment.

4. The method of claim 1, wherein the new file being composed by introducing the new component block in a first file including a set of component blocks, introduction of the new component block being one of replacing an existing component block and adding the new component block to the first file.

5. The method of claim 1, wherein the build of the new file is accomplished by gathering the new component block, according to the new value-block pair, and a portion of a first set of component blocks into an arrangement corresponding to a configuration delineated by the new set of key-value pairs.

6. The method of claim 1, further comprising:
transmitting a first set of key-value pairs delineating a configuration of a first file to the first client and
receiving, from the first client, an indication of completion of a build of the first file composed of a first set of component blocks configured according to the first set of key-value pairs.

7. A computer-readable storage medium embodying a set of instructions, that when executed by at least one processor, causes the at least one processor to perform operations comprising:
receiving, from a first client in a first network environment, a new component block being included in a new file;
responsive to receiving the new component block, generating a new key, a new hash value, a new key-value pair, and a new value-block pair corresponding to the new component block;
transmitting the new value-block pair to a second network environment, the new value-block pair being variously distributed by the transmission to a set of clients in the second network environment;
transmitting a new set of key-value pairs to a second client in the second network environment; and
receiving, from the second client, an indication of completion of a build of the new file.

8. The computer-readable storage medium of claim 7, wherein the new set of key-value pairs includes the new key-value pair and one of a portion of a first set of key-value pairs and a directive introducing the new key-value pair into a first set of key-value pairs.

9. The computer-readable storage medium of claim 8, wherein introducing the new key-value pair being one of replacement of an existing key-value pair and insertion of the new key-value pair in an existing set of key-value pairs in the second network environment.

10. The computer-readable storage medium of claim 7, wherein the new file being composed by introducing the new component block in a first file including a set of component blocks, introduction of the new component block being one of replacing an existing component block and adding the new component block to the first file.

11. The computer-readable storage medium of claim 7, wherein the build of the new file is accomplished by gathering the new component block, according to the new value-block pair, and a portion of a first set of component blocks into an arrangement corresponding to a configuration delineated by the new set of key-value pairs.

12. The computer-readable storage medium of claim 7, further comprising:
transmitting a first set of key-value pairs delineating a configuration of a first file to the first client and
receiving, from the first client, an indication of completion of a build of the first file composed of a first set of component blocks configured according to the first set of key-value pairs.

13. A system comprising:
a server including at least one processing device configured to implement:
a hashing module configured to produce hash values corresponding to key values;
a transposing module configured to transpose keys, hash values, and component blocks into key-value pairs and value-block pairs; and
a central layer configured to control the hashing module, the transposing module, and communications between client devices and the server, and
a computer memory including a set of image files.

14. A method comprising:
at a first client device in a first network environment, producing a new component block being included in a new file;
responsive to producing the new component block, generating a new key, a new hash value, a new key-value pair, and a new value-block pair corresponding to the new component block;
transmitting the new value-block pair to a server, the new value-block pair being variously distributed, according to the transmission, to a set of clients in a second network environment;
transmitting a new set of key-value pairs to the server; and
at a second client within the second network environment, producing a build of the new file according to the new set of key-value pairs.

15. The method of claim 14, wherein the new set of key-value pairs includes the new key-value pair and one of a portion of a first set of key-value pairs and a directive introducing the new key-value pair into a first set of key-value pairs.

16. The method of claim 15, wherein introducing the new key-value pair being one of replacement of an existing key-value pair and insertion of the new key-value pair in an existing set of key-value pairs in the second network environment.

17. The method of claim 14, wherein the new file being composed by introducing the new component block in a first file including a set of component blocks, introduction of the new component block being one of replacing an existing component block and adding the new component block to the first file.

18. The method of claim 14, wherein the build of the new file is accomplished by gathering the new component block, according to the new value-block pair, and a portion of a first set of component blocks into an arrangement corresponding to a configuration delineated by the new set of key-value pairs.

19. The method of claim 14, further comprising:
receiving a first set of key-value pairs delineating a configuration of a first file and
building the first file composed of a first set of component blocks configured according to the first set of key-value pairs.

20. A method comprising:
in a first network environment, receiving, from a first client operable with a first file delineated by a first set of key-value pairs, an indication of removal of a component block from the first file, removal of the component block producing a new file;
responsive to removal of the component block, producing a new set of key-value pairs by removing a key-value pair corresponding to the removed component Hock from the first set of key-value pairs;
transmitting the new set of key-value pairs to a second client in a second network environment; and
receiving, from the second client, an indication of completion of a build of the new file.
